(19) United States
(12) Patent Application Publication
(10) Pub. No.: US 2007/0065243 A1
(43) Pub. Date: Mar. 22, 2007

(54) Deep hole drill

(75) Inventor: Oldrich Bosman, Zbuch (CZ)

Correspondence Address: BURR & BROWN, PO BOX 7068, SYRACUSE, NY, 13261-7068, US

(73) Assignee: Joerg GUEHRING, Albstadt (DE)

(21) Appl. No.: 11/603,785

(22) Filed: Nov. 22, 2006

Related U.S. Application Data
(63) Continuation of application No. 11/154,769, filed on Jun. 16, 2005.
Application No. 11/154,769 is a continuation of application No. PCT/DE03/04273, filed on Dec. 18, 2003.

(30) Foreign Application Priority Data
Dec. 19, 2002 (DE) DE 202 19 753.0

(51) Int. Cl. B23D 77/00

(52) U.S. Cl. 408/199

(57) ABSTRACT

The invention relates to a deep hole drill consisting of three sections, a drill head, a shank and a clamping element. The drill head and the shank are provided with at least one preferably straight-grooved machined groove. In order to be able to carry out drilling in a more economic manner with improved feed values, the shank is made of a hard metal. The drill head can be made of a hard metal which is different from the hard metal of the shank.

This application is a continuation of International Application PCT/DE2003/004273, filed Dec. 18, 2003, the entirety of which is incorporated herein by reference.

### CROSS-REFERENCE TO RELATED APPLICATIONS

This application claims the benefit of German Patent Application No. 202 19 753.0, filed Dec. 19, 2002, the entirety of which is incorporated herein by reference.

### FIELD OF THE INVENTION

The invention relates to a deep hole drill.

### BACKGROUND OF THE INVENTION

Deep hole drills can be used to drill holes having a diameter of 1.0 to 20 mm with a ratio of drill length to diameter of up to 200:1 and a stroke length up to 100 times the diameter in individual cases in a single operation and in some cases even without pre-drilling. These drills are used nowadays for example in engine and ship building, especially in the manufacture of fuel injection systems. The requirement here is to produce holes having very small diameters (in the range of 1 mm) and very long hole lengths in relation thereto.

In this case, drilling is carried out with a small feed even into the full. At least one drill cutting edge is formed at the drill tip which has the actual cutting function whilst the shank must transfer the required torque over the length from the clamping element to the drill tip. Thus, generic deep hole drills are joined together from a drill head locally defined at the drill top and a shank extending over the length of the drill, made of different materials. In this case, the at least one drill cutting edge can be constructed directly on the drill head or a drill head with screwed-on changeable or turnover cutting plates can be used. Extremely different requirements are thus imposed on the drill head and shank. Whereas wear resistance and hardness are particularly important for the drill head, the shank must have a high toughness and torsional resistance. So far, these requirements have been taken into account by soldering a drill head consisting of hard metal onto a steel shank.

Two methods are available for manufacturing steel shanks for generic deep hole drills:

When the requirements for strength, torsional resistance and vibrational damping are high, solid-material round steel rods are used wherein internal cooling channels are drilled if necessary and, for example in the case of a single-lip deep hole drill, a machined groove is inserted.

In a cheaper variant of a single-lip deep hole drill although capable of withstanding less load, the drill shank is manufactured using a steel tube into which a lip is rolled.

During the manufacture of these known deep hole drills the choice of shanks which can be used is thus limited to two quality and price categories. As a result of the wide range of applications of deep hole drills, for example, in a wide range of materials to be drilled, frequently none of the shanks manufactured by the known methods are suitable for the operating conditions to be encountered.

### BRIEF SUMMARY OF THE INVENTION

Starting herefrom, it is thus the object of the invention to provide a deep hole drill with improved properties.

This object is solved by the present invention.

According to the invention, the shank consists of a hard metal. As a result, the loading limit for the deep hole drilling tool according to the invention can be increased considerably compared with those in conventional tools with a steel shank, and high length/diameter ratios can be achieved with good feed values. Nowadays, in addition to extremely hard metals, those having a highly tough consistency are also available which are best suited for satisfying the requirements imposed on the shank of a deep hole drilling tool. Hard metals consist of metallic hard materials which can be described as relatively brittle because of their high hardness, and binders or binder metal predominantly from the iron group (iron, cobalt, zinc) which are relatively soft and tough and are sintered together with the hard materials. Mixtures of ceramics and metals (cermets) are also included among the hard metals. In the hard metal the high hardness and therefore wear resistance of the metallic hard material is combined with the toughness of a binder metal. The desired properties of the drill shank can be adjusted exactly according to the mixing ratio.

Hard metal is certainly inherently more impact-resistant than steel. However, since constant torques and vibrational loadings occur over large sections in deep hole drills apart from at the material inlet and outlet, especially since the initial drilling always takes place with small feed with pilot holes and/or guide sleeves, the shock absorption behaviour of a drill shank made of hard metal is sufficient to withstand the impacts which occur. The invention thus succeeds in overcoming the technical prejudice that only steel is suitable as the material for shanks. Tests have shown that the high stiffness and the good vibrational damping of hard metal shafts results in a high manufacturing accuracy.

With the drill shank consisting of hard metal according to the invention it is furthermore possible to select an especially suitable material for the drill shank for a particular intended usage within a wide range of usage. The properties of a specific drill shank can thus be specially tailored for a specific area of application without the need to substantially vary the costs. Thus, when designing the drill shank, one is no longer restricted to the properties of the two known steel shank variants so that a drill specially adapted to its field of application in every field of application in metal processing achieves particularly high lifetimes whilst the costs remain low.

It is also advantageous if not only the shank consists of a hard metal but also the drill head. In this case, the different requirement profiles of the drill head and the drill shank are taken into account by selecting two different hard metals. Extremely hard types of metals which ensure good wear resistance are suitable for the drill head. Within the scope of the invention however, any other commonly used materials of modern high-power drills would also be suitable as material for the drill head, such as for example, high-speed steel such as HSS or HSSE, HSSEBM, ceramic, cermet or other sintered metal materials, if appropriate with usual coatings, at least in the area of the sharp cutting edges. Advantageous for this purpose are hard material layers, preferably executed as thin, where the layer thickness is preferably in the range between 0.5 and 3 μm.

The hard material layer consists, for example of diamond, preferably of monocrystalline diamond. It can also be executed as a titanium nitride or as a titanium aluminium nitride layer since these layers are deposited sufficiently thinly. In addition, nitride-hardened layers, cubic boron nitride, corundum, sialone or other non-metallic materials are suitable as coating material. It would also be feasible to use a drill head fitted with changeable or turnover cutting plates, which consists of HSS or hard metal itself, where the cutting plates consist of an even harder material, for example, ceramic or cermet or have this type of hard material coating.

In addition or alternatively, a soft material layer can also be used which is at least present in the area of the groove. This soft material coating preferably consists of MOS₂.

In one aspect of the present invention, a material of class K20 and/or K40 according to ISO 513 is provided for the shank. Material of class K20 and/or K40 according to ISO 513 which has a high hardness compared with other types of hard metal, is very tough compared to other types of hard metal so that the high torques produced during the drilling of hard materials can be transferred without fracture. In addition to long lifetimes, a long length of the drill shank and high feed values can thus be achieved.

A material of class K10 according to ISO 513 is advantageous for the drill head. This is because this material has an extremely high wear resistance compared to other types of hard metals and is thus suitable for the particularly high loads on the drill head especially when drilling short-chipping and very hard materials. A combination of a K10 drill head with a K20 or K40 drill is especially preferred.

The shank is preferably joined to the drill head by brazing or gluing. Other material-closing methods or screwing would also be feasible. In order to optimally fulfil the intended purpose, the deep drill tool preferably has a kidney-shaped inner cooling channel with which the cutting edges of the drill head can be cooled using a coolant during cutting and the swarf pressed through the machined groove out of the drilled hole.

In this way, a deep hole drill can be manufactured overall which can be adapted particularly variably to the operating conditions by means of the material properties of the hard metal.

Although hard metal is intrinsically more expensive than steel, it is found that the extrusion and sintering of the hard metal shank used in the method according to the invention for manufacturing the deep hole drilling tool is particularly inexpensive especially with long shanks. This is because it can be used to extrude a blank having a geometry which must possibly be reground to the finished dimension, i.e. the blank has a crimp which substantially corresponds to the machined groove of the shank.

The invention is especially suitable for single-lip deep hole drills with a straight machined groove. However, it is not restricted to a single-lip embodiment. In particular, spiral machined grooves or a multi-lip, especially a double-lip tool as well as a single-tube or double-tube tool are feasible since almost any geometries can be produced during extrusion of the tool.

The individual features of the embodiments according to the claims can be combined in any desired way as far as this appears logical.

### BRIEF DESCRIPTION OF THE DRAWING FIGURES

Preferred embodiments of the invention are explained in detail subsequently with reference to schematic drawings:

FIG. 1 is a perspective view of an embodiment of the deep hole drill according to the invention;

FIG. 2 is a cross-sectional view of the shank of the deep hole drill shown in FIG. 1; and

FIG. 3 is a plan view of the shank of the deep hole drill shown in FIG. 1.

### DETAILED DESCRIPTION OF THE INVENTION

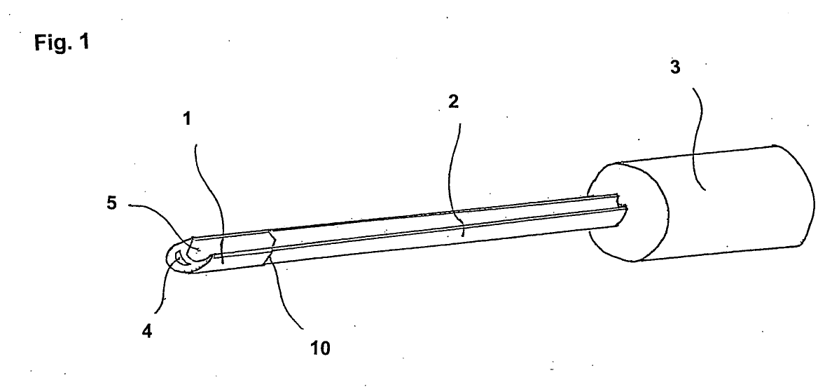

FIG. 1 shows a three-part deep hole drill according to the invention comprising a drill head 1, a shank 2 and a clamping element 3. The shank 2 and drill head 1 are soldered together at a joint seam 10. The shank 2 is guided into a recess of the clamping element 3 and soldered there to the clamping element 3. The clamping element is provided in the form of a clamping sleeve. Furthermore, the outlet opening of an inner cooling channel 4 can be seen at the drill tip, which channel extends through the length of the entire tool. In this case, the deep hole drill is executed as a single-lip drill with a straight-grooved machined groove 5. The drill head 1 is sintered from K10/ISO 513 hard metal whereas the shank 2 consists of a K20/ISO 513 hard metal.

The forces produced during cutting by the drill head 1 having a high hardness and wear resistance are transferred by the tough-material shank 2 to the clamping element 3. Low wear values can be achieved as a result of the good inherent stability and torsional resistance of the shank 2. The swarf produced during the cutting is floated out of the drilled hole through the straight machined groove 5 by means of a coolant supplied at high pressure through the inner cooling channel 4. As a result of the kidney shape of the cooling channel, a large quantity of coolant and good internal cooling are achieved with the smallest possible weakening of the material.

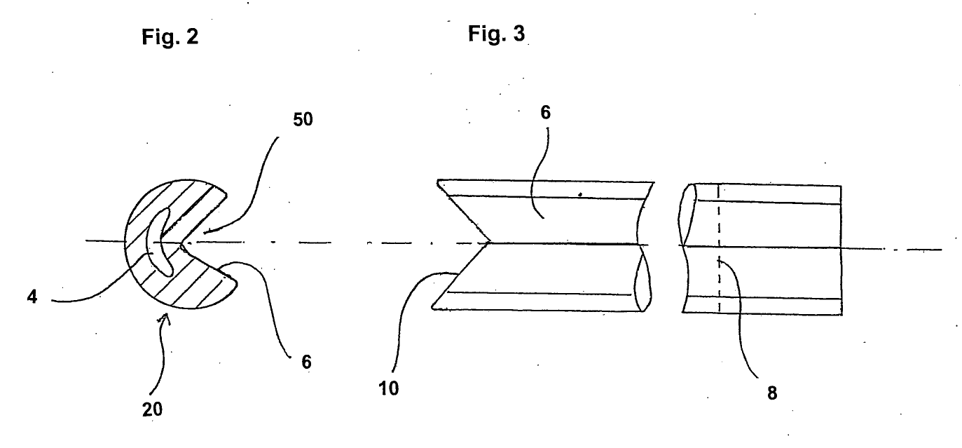

FIG. 2 shows the cross-sectional geometry of a sintered blank 20 which corresponds to the geometry of the final shank 2 apart from the small amount of material removed from the machined groove in the final processing. The relevant plan view of the sintered blank 20 can be seen from FIG. 3. The blank has been extruded with a crimp 50 and the internal cooling channel 4. Finishing treatment i.e., finish grinding is only carried out on the machined surface 6 and unmachined surface 6 of the crimp 50. The dashed line 8 indicates the end of the section of the shank with which the shank is soldered in the clamping element 3.

Naturally deviations from the embodiment shown are possible without departing from the scope of the invention.

Thus, for example, it would be feasible to provide the cutting edge not directly on the drill head of the single-lip deep hole drill but on a screwed-on changeable or turnover plate. An embodiment of the deep hole drill with more than one internal cooling channel, for example, two circular-cross-sectional cooling channels would also be feasible. Furthermore, trigonal or elliptical shapes could also be considered as the cooling channel geometry. In addition, spiral drill shapes with a hard metal shaft, for example, in a double cutting edge design with two spiral crimps or machined grooves and spiral cooling channels, for example, having an elliptical cross-section, would also be feasible.

1. A deep hole drill comprising three sections, a drill head, a shank and a clamping element, the drill head and the shank being provided with at least one machined groove, the shank being made of a hard metal.

2. The deep hole drill according to claim 1, wherein the drill head is made of a hard metal which is different from the hard metal of the shank.

3. The deep hole drill according to claim 1, wherein the shank is made of a hard metal of the class K20 or K40 according to ISO 513.

4. The deep hole drill according to claim 1, wherein the drill head is made of a hard metal of the class K10 according to ISO 513.

5. The deep hole drill according to claim 1, wherein the drill head is brazed or glued to the shank.

6. The deep hole drill according to claim 1, wherein at least one inner cooling channel is formed in said drill head.

7. The deep hole drill according to claim 1, wherein the shank consists of a sintered member which is obtained from a sintered blank with at least one crimp substantially corresponding to the machined groove.

8. The deep hole drill according to claim 1, wherein said machined groove is straight-grooved.

9. The deep hole drill according to claim 6, wherein said inner cooling channel is kidney-shaped.

10. The deep hole drill according to claim 1, wherein the deep hole drill consists of the drill head, the shank and the clamping element.

11. The deep hole drill according to claim 1, wherein said deep hole drill comprises two circular-cross-sectional cooling channels.
